(19) United States
(12) Patent Application Publication
(10) Pub. No.: US 2017/0344651 A1
(43) Pub. Date: Nov. 30, 2017

(54) IMAGE FORMING APPARATUS CAPABLE OF OPERATING BASED ON OPERATION INSTRUCTIONS RECEIVED FROM PORTABLE TERMINAL

(71) Applicant: KYOCERA Document Solutions Inc., Osaka (JP)

(72) Inventors: Kohei ISHIDO, Osaka (JP); Kenichi ONISHI, Osaka (JP)

(73) Assignee: KYOCERA Document Solutions Inc., Osaka (JP)

(21) Appl. No.: 15/607,365

(22) Filed: May 26, 2017

(30) Foreign Application Priority Data
May 26, 2016 (JP) 2016-105051

(51) Int. Cl. G06F 17/30; G08C 17/02

(52) U.S. Cl. CPC G06F 17/30867; H04N 2201/0075; G08C 17/02; H04N 2201/0055

(57) ABSTRACT

Provided is an image forming apparatus that optimizes the operating environment to correspond to a user. The image forming apparatus is capable of operating based on operation instructions received from a portable terminal of the user. The image forming apparatus includes a short-range-wireless-communication unit, an operating-environment-setting unit and an operation panel. The short-range-wireless-communication unit receives personal information data that includes either or both the physical condition and the nationality of the user by short-range wireless communication from the portable terminal. The operating-environment-setting unit sets an operating environment based on the received personal information data. The operation panel displays a display screen on which the operation instruction from the portable terminal is reflected in the set operating environment.

### INCORPORATION BY REFERENCE

This application is based on and claims the benefit of priority from Japanese Patent Application No. 2016-105051 filed on May 26, 2016, the contents of which are hereby incorporated by reference.

### BACKGROUND

The present disclosure relates to an image forming apparatus that is capable of operating based on operation instruction received from a portable terminal of a user.

In an image forming apparatus such as a printer, a copier, a multifunction peripheral and the like, an operation panel for receiving various settings is provided, and a user can use the image forming apparatus by changing the settings as desired respectively. In this kind of image forming apparatus, there are devices that receive operations by performing wireless communication with a portable terminal such as a smart phone, tablet terminal and the like. In typical technology, setting information such as paper settings, density settings and the like are received from a portable terminal by short-range wireless communication, and reflected on the settings.

### SUMMARY

The image forming apparatus of this disclosure is an image forming apparatus that is capable of operating based on operation instructions received from a portable terminal of a user. The image forming apparatus includes a short-range-wireless-communication unit, an operating-environment-setting unit and an operation panel. The short-range-wireless-communication unit receives personal information data that includes either or both the physical condition and the nationality of the user by short-range-wireless communication from the portable terminal. The operating-environment-setting unit sets an operating environment based on the received personal information data. The operation panel displays a display screen on which the operation instruction from the portable terminal is reflected in the set operating environment.

### BRIEF DESCRIPTION OF THE DRAWINGS

FIG. 1 illustrates the system configuration of an image-forming system of an embodiment of the present disclosure.

FIG. 2 is a function block diagram illustrating the schematic configuration of the portable terminal illustrated in FIG. 1.

FIG. 3 is a function block diagram illustrating the schematic configuration of the image forming apparatus illustrated in FIG. 1.

FIG. 4 is a flowchart illustrating the flow of the operating-environment-setting operation of the image-forming system illustrated in FIG. 1.

FIG. 5 illustrates an example of setting contents for the operating environment by the operating-environment-setting unit illustrated in FIG. 3.

### DETAILED DESCRIPTION

In the following, embodiments of the present disclosure will be explained in detail with reference to the drawings. In the embodiments below, the same reference numbers will be used for configuration that indicates the same function.

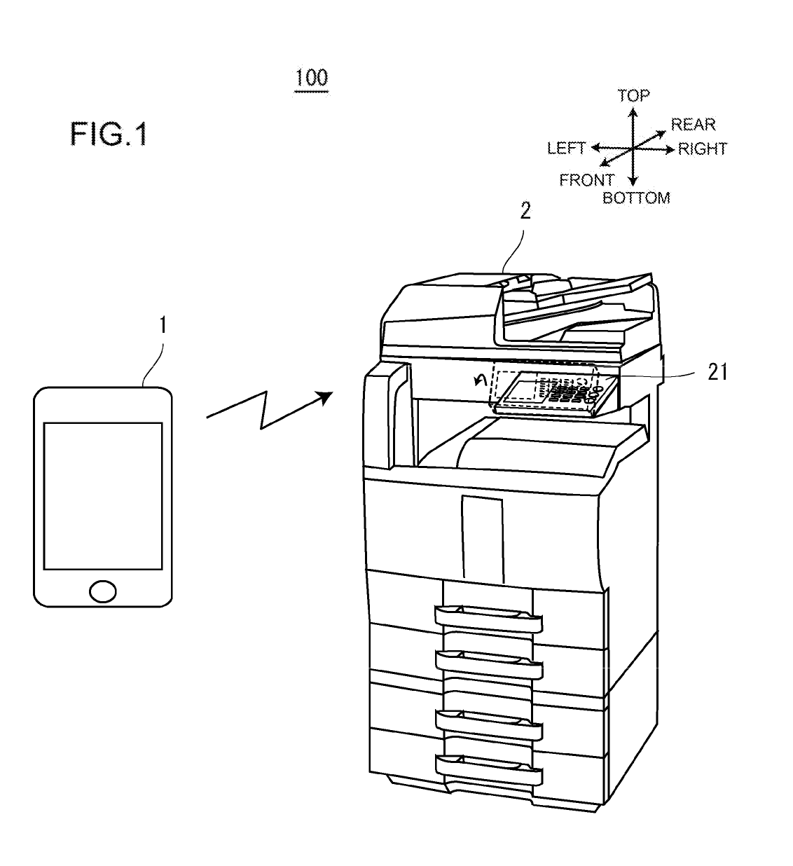

As illustrated in FIG. 1, an image-forming system 100 includes a portable terminal 1 and an image forming apparatus 2. The image forming apparatus 2, together with being configured so as to be able to operate by receiving operation instructions from the portable terminal 1 of a user, can be operated from an operation panel 21. Moreover, the operation panel 21 of the image forming apparatus 2 is configured so as to be able to tilt, and can be tilted forward in a direction toward the front side of the main unit.

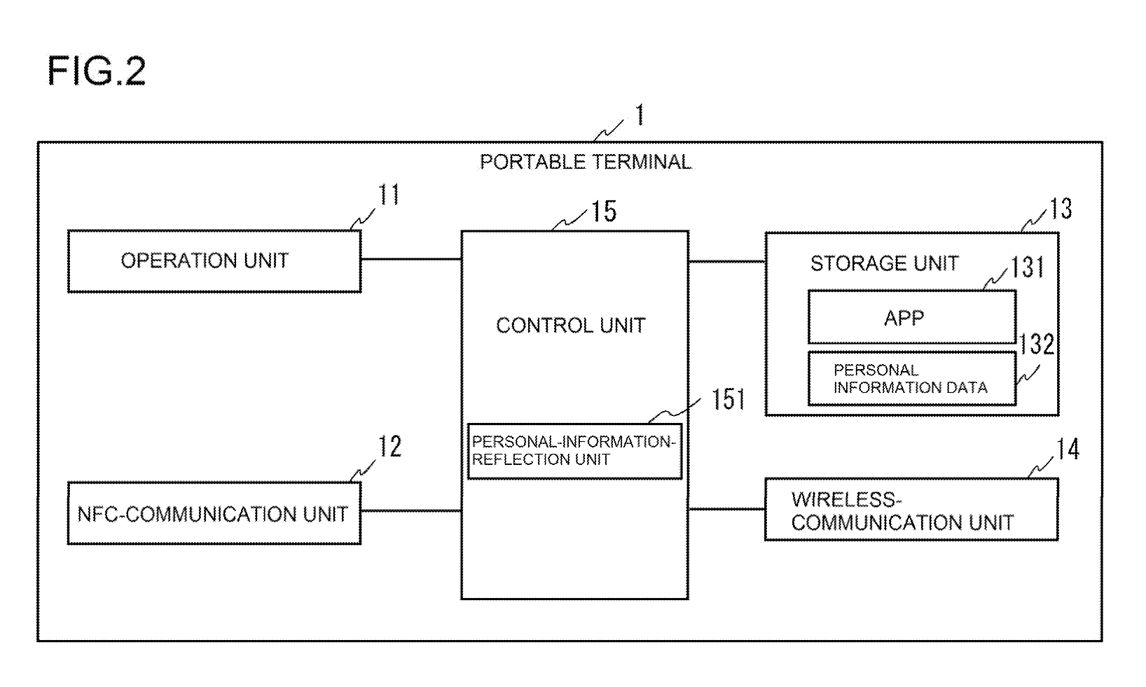

The portable terminal 1 is a portable device such as a smart phone, a tablet terminal, a PDA (Personal Digital Assistant) and the like, and his held by a user. As illustrated in FIG. 2, the portable terminal 1 includes an operation unit 11, a NFC-communication unit 12, a storage unit 13, a wireless-communication unit 14, and a control unit 15.

The operation unit 11 is a user interface that includes a display unit for displaying various kinds of information, and various operation keys. The display unit may be a touch panel that functions as display and input means, and the surface of the display panel is provided with transparent pressure sensors.

The NFC-communication unit 12 has an NFC (Near Field Communication) short-range wireless communication function, and can transmit or receive data to or from NFC tags 27. The NFC-communication unit 12 can transmit or receive data by establishing short-range wireless communication with the NFC tag 27 using a hold over operation of the portable terminal 1 with respect to the NFC tag as a trigger. Therefore, wireless communication settings by the user are not necessary, and the NFC-communication unit 12 can be easily used.

The storage unit 13 is storage means such as a semiconductor memory, HDD (Hard Disk Drive) and the like, and stores an APP 131. The APP 131 is an application program for optimizing the operating environment of the image forming apparatus 2 for the user, and is installed in the portable terminal 1. The user can download the APP 131 from the Internet or the like by way of the wireless-communication unit 14, and install the APP 131 in the portable terminal 1. Moreover, personal information that is inputted by the user during initial startup of the APP 131 is stored in the storage unit 13 as personal information data 132.

The wireless-communication unit 14 has a function for transmitting or receiving various kinds of data to or from the image forming apparatus 2 by way of a wireless network. The wireless-communication unit 14 may also use a portable telephone communication network as the wireless network, and may also use Wi-Fi (registered trademark) or Bluetooth (registered trademark).

The control unit 15 is connected to the operation unit 11, the NFC-communication unit 12, the storage unit 13 and the wireless-communication unit 14, respectively, and executes overall operation control of entire portable terminal 1 according to specific instruction information that is inputted from the operation unit 11. The control unit 15 is an information processing unit such as a microcomputer that includes ROM (Read Only Memory), RAM (Random Access Memory) and the like. A control program for performing operation control of the portable terminal 1 is stored in ROM. The control unit 15 reads the control program that is stored in ROM, and by expanding the control program in RAM, performs overall control of entire terminal according to specific instruction information that is inputted from the operation unit 11.

Moreover, when the startup operation for the APP 131 is performed by way of the operation unit 11, the control unit 15 reads the APP 131 that is stored in the storage unit 13, and expands the APP 131 in RAM and starts the APP 131. As a result, the control unit functions as a personal-information-reflection unit 151 for achieving the function of the APP 131.

The personal-information-reflection unit 151, during initial startup, receives input of personal information by way of the operation unit 11 that includes either or both the physical condition and nationality of the user. The personal information that is inputted by the user includes the name, nationality, gender, height, wheelchair use or not use, age, vision, hearing, FAX number, e-mail address, and the like. The physical conditions of the user that are included in the personal information are the gender, height, wheelchair use or not use, age, vision and hearing. The personal information that is inputted during initial startup is stored in the storage unit 13 as personal information data 132, and input can be omitted from the next time on. After the personal information data 132 is stored in the storage unit 13, the personal-information-reflection unit 151 causes a prompt message to be displayed on the operation unit 11 that prompts the user to touch the portable terminal 1 on the NFC tag 27 of the image forming apparatus 2. When the user touches the portable terminal 1 on the NFC tag 27, short-range wireless communication is established between the NFC-communication unit 12 and the NFC tag 27, and the NFC-communication unit 12 transmits the personal information data 132 that is stored in the storage unit 13 to the NFC tag 27.

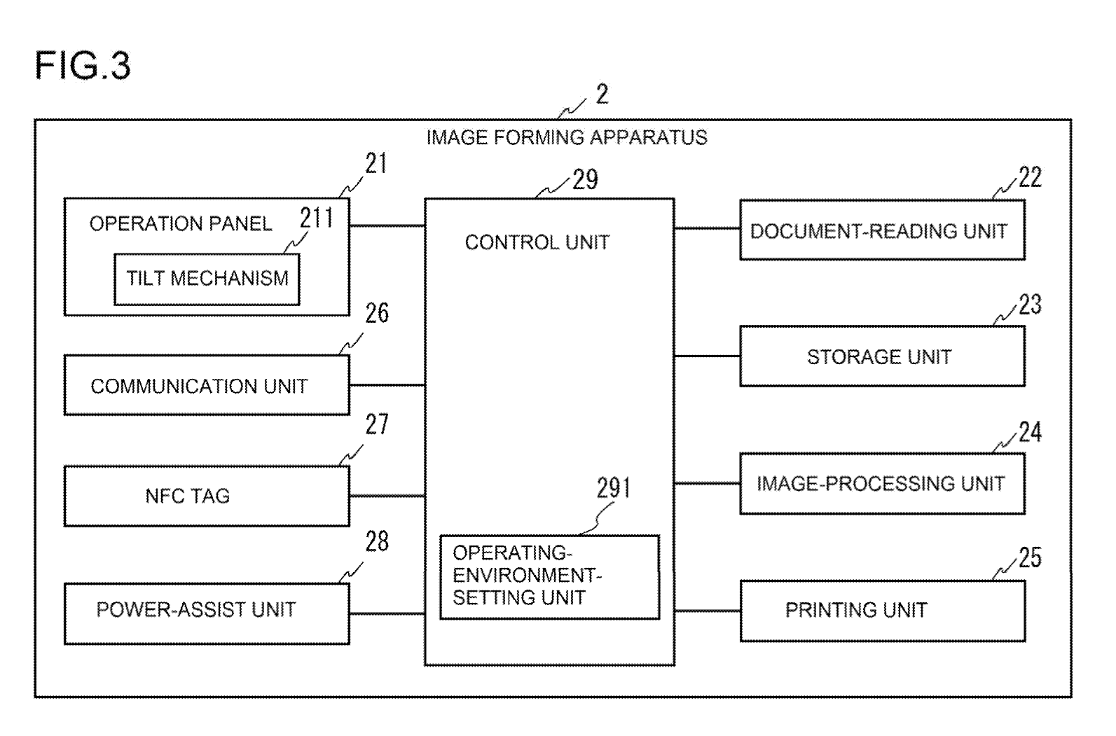

Next, the image forming apparatus 2 will be explained with reference to FIG. 3. The image forming apparatus 2 is a MFP (Multifunction Printer), and includes an operation panel 21, a document-reading unit 22, a storage unit 23, an image-processing unit 24, a printing unit 25, a communication unit 26, an NFC tag 27 and a control unit 29.

The operation panel 21 includes a touch panel and operation buttons. The touch panel functions as display and input means, and the surface of the display unit displays various kinds of operation keys and image-forming status and is provided with transparent pressure sensors. The touch panel detects a touch operation on the display surface, and by outputting a signal that corresponds to the position where the touch operation was detected, receives operation of the operation keys that are displayed on the display unit. Moreover, the operation buttons include various keys such as a ten-key for inputting number values such as the number of sheets of printing, a reset key for inputting an instruction to initialize the setting information, a stop key for stopping a copy operation, and a start key for inputting an output instruction for starting a printing operation. The operation panel 21 is also provided with a tilt mechanism 211 in which a rotating shaft is arranged in the horizontal direction of the image forming apparatus 2, and the panel angle (panel angle) can be variably adjusted (tilted) in the vertical direction with respect to a vertical plane by the control unit 29.

The document-reading unit 22 is a scanner that reads a document image by irradiating light onto a document that is supplied by a document-feeding device or a document that is placed on the platen glass by the user, and receiving the light that is reflected.

The storage unit 23 is storage means such as a semiconductor memory, HDD or the like, and is storage means for storing image data that is read by the document-reading unit 22, image data that is received by the communication unit 26 and the like.

The image-processing unit 24 is means for performing specific image processing on image data. In the image-processing unit 24, image improvement processing such as enlargement/reduction processing, density adjustment, gradation adjustment and the like are performed.

The printing unit 25 is printing means for printing image data that is stored in the storage unit 23. The printing unit 25, for example, forms a latent image on a surface of a photosensitive drum based on image data that is read from the storage unit 23, performs image formation that uses toner to make the latent image a toner image, transfers the toner image from the photosensitive drum to printing paper, fixes the toner image on the printing paper and outputs the paper.

The communication unit 26 has a function for transmitting and receiving various kinds of data to or from the portable terminal 1 by way of a wireless network such as Wi-Fi (registered trademark), Bluetooth (registered trademark) or the like. In addition, the communication unit 26 may also have a function for transmitting and receiving various kinds of data to or from an external terminal by way of a LAN (Local Area Network) cable.

The NFC tag 27 includes an antenna and an IC (Integrated Circuit). The NFC tag 27 is such that when a portable terminal 1 in which an NFC function is mounted approaches, the IC chip is activated, and transmits or receives data to or from the portable terminal 1. Data that is received by the NFC tag 27 is stored in a memory in the IC chip. Instead of the portable terminal 1, an NFC-communication unit 12 may be provided in the image forming apparatus 2, and an NFC tag 27 may be provided on the portable terminal 1. In that case, when personal information data 132 is stored in the NFC tag 27 of the portable terminal 1 and the portable terminal 1 is touched by the image forming apparatus 2, the NFC-communication unit 12 that is provided in the image forming apparatus 2 is able to read the personal information data 132 from the portable terminal 1 using short-range wireless communication.

A power assist unit 28 has a function for assisting the opening/closing operation for the paper-supply cassette that supplies printing paper, or opening/closing operation of the transport cover for removing a paper jam. The paper-supply cassette and the transport cover are each provided with a known assist mechanism for assisting in opening and closing. When the power assist unit 28 is set to ON, and an opening operation for a paper-supply cassette or transport cover is detected, the power assist unit 28 makes the paper-supply cassette or transport cover stick out for example, making it easier to open the paper-supply cassette or transport cover. When a closing operation for a paper-supply cassette or transport cover is detected, the power assist unit 28 performs control so that the paper-supply cassette or transport cover retracts and is closed, for example. When the power assist unit 28 is set to OFF, control for assisting a paper-supply cassette or transport cover is not performed.

The control unit 29 is connected to the operation panel 21, the document-reading unit 22, the storage unit 23, the image-processing unit 24, the printing unit 25, the communication unit 26, the NFC tag 27, and the power assist unit 28, respectively. The control unit 29 is an information-processing unit such as a microcomputer that includes a ROM, RAM and the like. A control program for performing operation control of the image forming apparatus 2 is stored in the ROM. The control unit 29 reads the control program that is stored in the ROM, and by expanding the control program in the RAM, performs overall control of the device. Moreover, when the NFC tag 27 receives personal information data 132 from a portable terminal 1, the control unit 29 functions as an operating-environment-setting unit 291 that sets the operating environment based on the received personal information data 132.

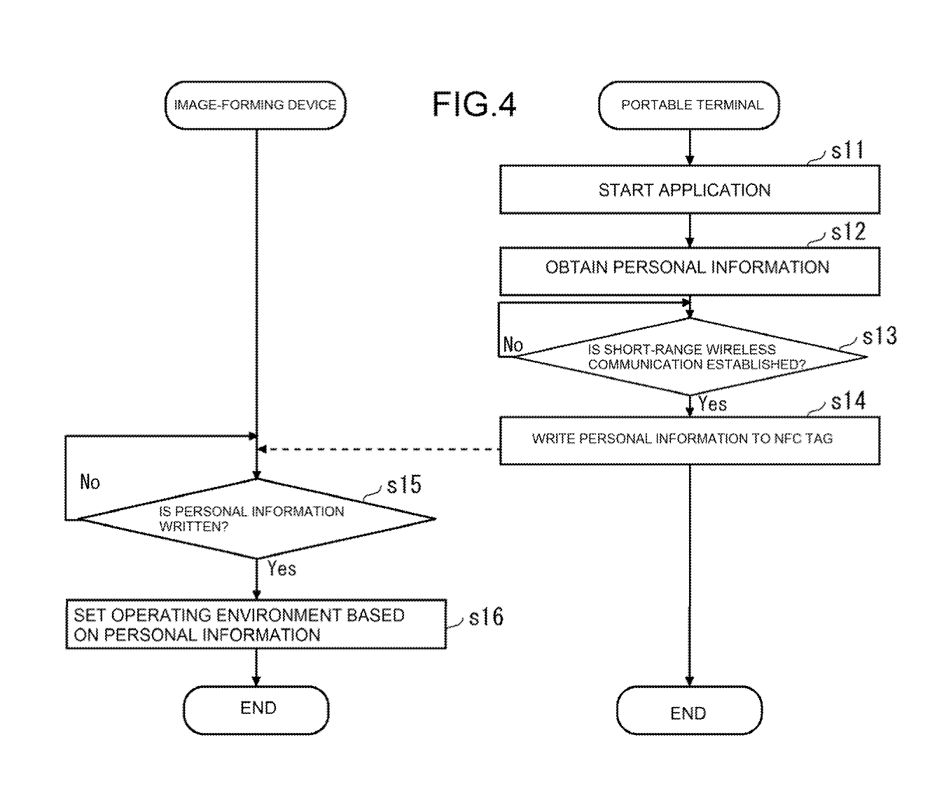

Next, the flow of the operating-environment-setting operation of the image-forming system 100 will be explained with reference to FIG. 4.

First, when the operation unit 11 of the portable terminal 1 receives a startup operation for the APP 131, the control unit 15 starts the APP 131 (step s11), and functions as a personal-information-reflection unit 151. The personal-information-reflection unit 151 obtains person information data 132 that is stored in the storage unit 13 (step s12). Continuing, the NFC-communication unit 12 waits until NFC short-range wireless communication is established (step s13, NO in step s13). When the user holds the portable terminal 1 over the NFC tag 27 of the image forming apparatus 2, short-range wireless communication is established between the NFC-communication unit 12 and the NFC tag 27 (YES in step s13). When short-range wireless communication is established, the NFC-communication unit 12 writes the personal information data 132 to the NFC tag 27 (step s14), and ends this process.

The operating-environment-setting unit 291 of the image forming apparatus 2 waits until the personal information data 132 is written to the NFC tag 27 (step s15, NO in step s15). After the personal information data 132 is written (YES in step s15), the operating-environment-setting unit 291 performs the operating-environment setting based on the personal information data 132 (step s16), and ends this process.

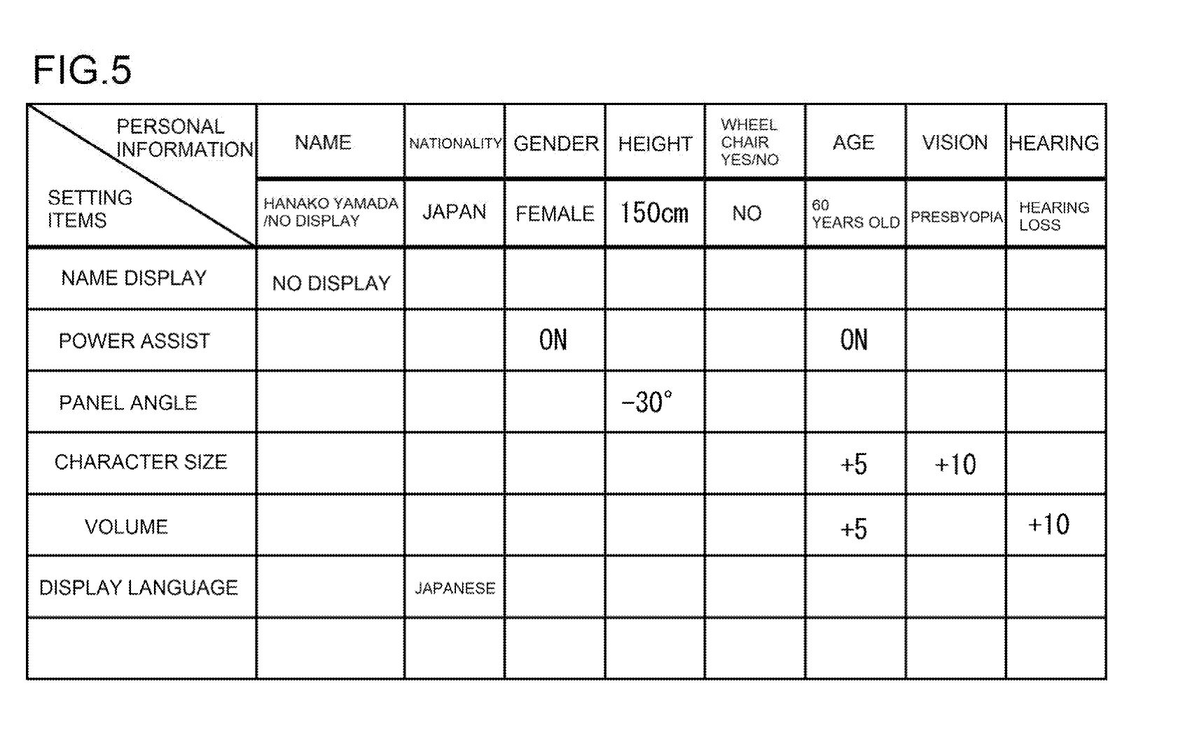

FIG. 5 is an example of the setting contents of the operating environment that is performed by the operating-environment-setting unit 291. The operating-environment-setting unit 291, based on the personal information data 132, sets whether or not to display the name, power assist, the panel angle of the operation panel 21, character size, volume, display language, and the like.

In the operating environment setting based on the name, when the user allows the name to be displayed, the operating-environment-setting unit 291 displays the name, for example, “Hanako Yamada: Dedicated Settings” on the operation panel 21, and indicates that the operating environment of the image forming apparatus 2 is in an optimally set state for an individual. Displaying or not displaying the name can be selected when the user inputs the personal information. When not displaying the name is selected, “User: Dedicated Settings” is displayed on the operation panel 21, indicating that the operating environment is optimally set, however, the personal name is not displayed.

In the operating environment setting based on nationality, the operating-environment-setting unit 291 determines the official language of the user based on the nationality, and sets the display language. For example, when the nationality is Japanese, the operating-environment-setting unit 291 sets the display language to Japanese.

In the operating environment setting based on gender, the operating-environment-setting unit 291 determines the muscular strength of the user based on gender, and sets whether or not to perform assistance by the power assist unit 28. For example, when the gender is female, muscular strength is determined to be low, and power assist is set to ON, and the power assist unit 28 perform assistance for pulling out or inserting a paper-supply cassette, or for opening or closing the transport cover. When the gender is male, muscular strength is determined to be standard, so power assist remains OFF, and the power assist unit 28 does not perform assistance.

In the operating environment setting based on height, the operating-environment-setting unit 291 determines the eye level of the user based on height, and adjusts the panel angle of the operation panel 21 to correspond to the eye level of the user. For example, when the height is 150 cm, the operating-environment-setting unit 291 determines that the eye level of the user is low, and controls the tilt mechanism 211 of the operation panel 21 to set the panel angle to tilt −30° from the reference position (reference angle). As a result, the operation panel 21 is tilted forward to correspond to the eye level of the short user, making it easier to operate the operation panel 21. When the height is 160 cm or greater, for example, it is determined that the eye level of the user is standard, and the panel angle can be set as is at the standard position.

In the operating environment setting based on whether or not a wheelchair is used, the operating-environment-setting unit 291 determines the eye level of the user based on whether or not a wheelchair is used, and sets the panel angle of the operation panel 21 to correspond to the eye level of the user. For example, when a wheelchair is used, the operating-environment-setting unit 291 determines that the eye level of the user is low, and controls the tilt mechanism 211 to set the adjustment value for the panel angle to −60° and tilts the operation panel forward to correspond with the eye level of a user that is seated in a wheelchair. When the setting is set that a wheelchair is not used, the eye level of the user is determined to be standard, and the panel angle remains at the default value.

In the operating environment setting based on age, the operating-environment-setting unit 291 determines the muscular strength, visibility and hearing based on the age, respectively, a sets whether or not to perform assistance by the power assist unit 28, sets the character size of the display screen, and sets the volume of the speaker, respectively. For example, when the age is 60 years old or greater, the operating-environment-setting unit 291 determines that the muscular strength, visibility and hearing are each low, and sets power assist to ON, sets the character size to be displayed larger by adding an adjustment value of +5 to the default value, and sets the volume to be higher by adding an adjustment value of +5 to the default value. When the age is less than 60 years old, the operating-environment-setting unit 291 determines that the muscular strength, visibility and hearing are each standard, so each of the settings may be set as is to the default value. Moreover, as the age increases from 60 years old, the operating-environment-setting unit 291 may perform settings such as setting power assist to ON, increasing the adjustment values for both the character size and volume, respectively. Moreover, even when the age is 10-years old or younger, the operating-environment-setting unit 291 may set the power assist to ON, and add an adjustment value to the character size and speaker volume, and may also change the displayed characters to be all “Hiragana” so as to be easy to read even by a child.

In the operating environment setting based on vision, the operating-environment-setting unit 291 determines the visibility of the user based on vision, and sets the character size of the display screen. For example, in the case of astigmatism, myopia or presbyopia, the operating-environment-setting unit 291 determines that the visibility of the user is low and performs adjustment to make the character size larger than the standard; for example, in the case of presbyopia, performs adjustment by adding +10 as an adjustment value for the character size. When the vision is standard, the visibility of the user is determined to be standard, and the character size is set to the default value as is.

In the operating environment setting based on hearing, the operating-environment-setting unit 291 determines the hearing of the user, and sets the speaker volume. For example, when hearing is a hearing loss, the operating-environment-setting unit 291 determines that the hearing of the user is low, and adds +10 as an adjustment value to the default value for the volume. When the hearing is set to standard, for example, the hearing of the user is determined to be standard, and the volume of the speaker is set to the default value.

In FIG. 5, as in the case of the adjustment value for the character size, the adjustment value may be added in duplicate for the same setting item. In that case, the adjustment value for the case when the age is 60 years old, and the adjustment value for the case of vision with presbyopia, both are added to the default value for the character size. In other words, the character size is displayed larger for a user that is 60 years old and has presbyopia with vision than a user that is 60 years old and has no problem with vision, so the operating environment is set to correspond to the physical condition of the user.

It is not displayed in FIG. 5, however when a FAX number is included in the personal information data 132, it becomes possible to call the FAX number as a FAX transmission destination. Moreover, when an e-mail address is included in the personal information data 132, it becomes possible to call the e-mail address as a transmission destination for a scanned image.

In this way, the image forming apparatus 2 of this embodiment is an image forming apparatus 2 that is capable of operation based on an operating instruction that is received from the portable terminal of a user. The image forming apparatus 2 includes a short-range-wireless-communication unit (NFC tag 27), an operating-environment-setting unit 291, and an operation panel 21. The short-range-wireless-communication unit (NFC tag 27) receives personal information data 132 that include either one or both of the physical condition and nationality of the user by short-range-wireless communication from the portable terminal 1. The operating-environment-setting unit 291 sets the operating environment based on the received personal information data 132. The operation panel 21 displays a display screen that reflects an operating instruction that is received from the portable terminal 1 in the set operating environment. As a result, when the user wants to check that the operating instruction that is received from the portable terminal 1 is reflected correctly at the image forming apparatus 2, the operating environment of the image forming apparatus 2 is set based on the personal information such as the physical condition or nationality of the user, so the operating environment can be optimized for the user. Moreover, the operating environment of the image forming apparatus 2 is set based on the personal information of the user, so it is possible to provide the user with an optimized operating environment that can be realized by the image forming apparatus 2 without depending on the model of the image forming apparatus 2.

In this embodiment, an example was explained in which name display or not display, power assist, panel angle, character size, volume, and display language are set based on personal information of the user, however, needless to say, these settings are each performed to correspond to the model of image forming apparatus 2. For example, in the case of an image forming apparatus 2 that does not have a setting function for power assist or panel angle, the operating environment is optimized for the items such as the name display or not display, character size, volume, display language and the like that can be set.

Moreover, operating instructions that are transmitted from the portable terminal 1 to the image forming apparatus 2 may be transmitted together with the personal information data 132 using short-range-wireless communication to the image forming apparatus 2, or may be transmitted to the image forming apparatus 2 before or after transmitting the personal information data 132 using short-range-wireless communication or wireless communication. Furthermore, printing data, setting values and the like may also be included in an operating instruction that is transmitted from the portable terminal 1 to the image forming apparatus 2.

When a change to the operating environment that is set based on personal information data 132 is received by the operation panel 21, the image forming apparatus 2 may transmit the changed setting value to the personal terminal 1. When the changed setting value is received, the portable terminal 1 transmits the changed setting value after that to the image forming apparatus 2 instead of personal information data 132 using short-range wireless communication. As a result, the personal information data 132 that is transmitted the next time from the portable terminal 1 will be the setting values that are changed by the user, and an operating environment that is easy for the user to use will be reflected. Moreover, the image forming apparatus 2 stores connection setting information that is necessary for wireless communication with the communication unit 26 beforehand in the NFC tag 27, and when short-range-wireless communication is performed between the NFC tag 27 and the portable terminal 1, the connection setting information of the NFC tag 27 is transmitted to the portable terminal 1, and wireless communication between the communication unit 26 of the image forming apparatus 2 and the wireless-communication unit 14 of the portable terminal 1 may be established. Then, by transmitting the changed operating environment settings from the communication unit 26 to the portable terminal 1 using wireless communication, the user may optimally set the operating environment of the image forming apparatus 2 based on personal information by simply performing a touch operation for transmitting personal information data 132, and even when the operating environment is changed by way of the operation panel 21, it is possible for the portable terminal 1 to automatically collect the changed setting values.

In the typical technology described above, in order to check that setting information is accurately reflected at the image forming apparatus or in order to change setting information, the user performs an operation using the operation panel even when setting information is transmitted from the portable terminal to the image forming apparatus. When doing this, when the display language of the operation panel is different than the native language of the user, or when the character size is small, the user must manually change the settings. However, for a user that is not used to operating, it may take a long time for arriving at the setting screen for the display language or character size, and when the user has weak vision, changing the settings itself is difficult.

The present disclosure takes into consideration the situation described above, and according to the present disclosure it is possible to optimize the operating environment to correspond to a user.

The present disclosure is not limited to the embodiment described above, and needless to say, various modifications can be made without departing from the scope of the present disclosure.

What is claimed is:

1. An image forming apparatus that is capable of operating based on operation instructions received from a portable terminal of a user, comprising:
a short-range-wireless-communication unit that receives personal information data that includes either or both the physical condition and the nationality of the user by short-range wireless communication from the portable terminal;
an operating-environment-setting unit that sets an operating environment based on the received personal information data; and
an operation panel that displays a display screen on which the operation instruction from the portable terminal is reflected in the set operating environment.

2. The image forming apparatus according to claim 1, wherein
the operation panel is configured so as to be able to variably adjust the panel angle in the vertical direction with respect to a vertical plane; and
the operating-environment-setting unit
sets the panel angle by determining the eye level of the user based on the physical condition that is included in the personal information data.

3. The image forming apparatus according to claim 1, wherein
the operating-environment-setting unit
sets the display language by determining the official language of the user based on the nationality that is included in the personal information data.

4. The image forming apparatus according to claim 1, wherein
the operating-environment-setting unit sets the character size of the display screen by determining the visibility of the user based on the physical condition that is included in the personal information data.

5. The image forming apparatus according to claim 1, further comprising
a power assist unit that assists in the opening and closing operation of a paper-supply cassette or a transport cover; and wherein
the operating-environment-setting unit
sets whether or not to perform assistance by the power assist unit by determining the muscular strength of the user based on the physical condition that is included in the personal information data.

6. The image forming apparatus according to claim 1, wherein
the operating-environment-setting unit
sets the volume by determining the hearing capability of the user based on the physical condition that is included in the personal information data.

7. The image forming apparatus according to claim 1, further comprising
a communication unit that establishes wireless communication with the portable terminal using short-range wireless communication of the short-range communication unit; wherein
when changes to the operating environment that is set by the operating-environment-setting unit are received by the panel unit, the communication unit uses wireless communication to transmit the setting values of the changed operating environment to the portable terminal.
